(19) United States
(12) Patent Application Publication
(10) Pub. No.: US 2009/0147239 A1
(43) Pub. Date: Jun. 11, 2009

(54) APPARATUS AND METHOD FOR TRACKING AN OBJECT

(75) Inventors: Xiang Zhu, Ottawa (CA); I. Christine Smith, Ottawa (CA)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: Neptec

(21) Appl. No.: 12/065,453

(22) PCT Filed: Aug. 9, 2006
(86) PCT No.: PCT/CA06/01314

§ 371 Date: Aug. 29, 2008

Related U.S. Application Data
(60) Provisional application No. 60/713,338, filed on Sep. 2, 2005.

(51) Int. Cl. G01C 3/00

(52) U.S. Cl. 356/3.12; 356/5.01

(57) ABSTRACT

An apparatus for tracking an object or measuring the range of an object comprises a beam generator for generating first and second beams of energy and projecting the first and second beams towards a target surface whose distance from the apparatus is to be measured, a receiver for receiving energy from the first and second beams reflected from the target surface and for projecting beam energy reflected from the first beam onto a detector for detecting the position of the first beam energy. The position is dependent on the angle between the incident first beam and reflected first beam energy at the target surface, and thereby on the distance between the apparatus and the position from which the first beam is reflected from the surface. A second detector is provided for receiving second beam energy reflected from the target surface for measuring the range of the target by time of flight.

### FIELD OF THE INVENTION

The present invention relates to apparatus and methods for tracking objects, and in particular but not limited to, apparatus and methods for measuring the distance to an object.

### BACKGROUND OF THE INVENTION

Existing, optical-based systems for measuring the range of an object include LIDAR (light detection and ranging) systems in which a laser beam is projected onto an object and laser light reflected from the object is detected. Examples of LIDAR systems are shown in schematically in FIGS. 1 to 4.

Referring to FIG. 1, the system 1 includes a laser source 3, a first lens 5, a beam splitter 7, an optical scanner 9, a second lens 11 and a detector 13. A projected pulsed laser beam 15 from the source 3 passes through the first lens 5 and beam splitter 7 to the optical scanner, which controls the beam direction to project the beam onto an object (not shown) whose range is to be measured. The optical scanner 9 also receives laser light reflected from the object and is arranged so that the component of the return beam 17 between the object and the scanner that is co-aligned with the projected beam from the scanner 9 always falls on the detector 13. The beam splitter 7 reflects the return beam at 90° onto the detector 13 via the second lens 11. The range is measured using a Time of Flight (TOF) technique based on the time interval between the pulsed, projected and detected beams.

FIG. 2 shows another example of a LIDAR optical system which measures range using Time of Flight. The system 21 includes a laser source 23, a parabolic lens 25, an optical scanner 27 and a detector 29. A pulsed, projected laser beam 31 from the laser source 23 passes through the parabolic lens 25 to the optical scanner 27, which directs the projected beam onto an object whose range is to be measured. The optical scanner receives a return beam 33 reflected from the object and which is co-aligned with the projected beam 31, directs the return beam onto the parabolic lens 25, which reflects and focuses the return beam onto the detector 29.

A key requirement for the LIDAR optical systems shown in FIGS. 1 and 2, is that the return beam is co-aligned with the launched beam when it hits the optical scanner, so that the return beam will always fall on the detector, irrespective of the scanning direction. A drawback of these co-aligned optical systems is the requirement of a very large dynamic range. For example, if a LIDAR is designed to have a range from 0.5 meters to 3 kilometers, according to the LIDAR equation, the dynamic range required will be 75.5 dB (=10×log (3000/0.5)²) before even considering the variation of target reflectance. Thus, these systems cannot be used to detect targets at very short range due to the saturation of the receiving detector. Another drawback of these systems is the difficulty in detecting objects located in fog or mist or an atmosphere containing airborne particulate matter such as dust or sand. Fog, mist or particulate matter close to the LIDAR instrument reflects projected light back into the detector and the intensity of this locally reflected light can be much higher than the co-aligned component of light reflected from a distant target object, so that the small signal cannot be separated from the noise at the low sensitivity setting of the detector required to maintain the detector in a non-saturated state. Another drawback of the systems shown in FIGS. 1 and 2 is the effective attenuation of the rejected and reflected beams caused by the presence of the beam splitter and parabolic lens, respectively.

Another example of a LIDAR optical arrangement measures range using triangulation in which the angle of the beam reflected from an object depends on its range.

In an active triangulation system, a beam of radiation such as laser light is projected onto an object, and a position sensitive detector detects the position of the beam reflected from the object. Distance information, i.e. the position of the surface region of the object struck by the beam in the z-direction, otherwise known as the range, is derived mathematically from the projection direction as given by the angular position of the beam scanning mechanism and the position of the reflected beam as measured by the position sensitive detector. FIGS. 3 and 4 show a schematic diagram of a one-dimensional triangulation system, i.e. a system which measures range information only. The system 41 comprises a laser source 43, a projection lens 45, a collection lens 47 and a detector array 49, and the laser source and detector are spaced apart by a fixed distance in a bi-static arrangement. A laser beam 51 is projected onto a target object 53 and the reflected beam 55 is imaged by the lens 47 onto the detector array 49. When the target moves in the range direction (for example as indicated by the arrow “R”), the corresponding spot image moves along the array.

By trigonometry, the (x, z) coordinates of the illuminated point on the object are given by

$$z = \frac{{kf}_{0}}{p + {f}_{0} tan α}$$

and x=ztanα, where p is the position of the imaged spot on the detector, α is the deflection angle of the laser beam, k is the separation between the lens and the laser source, and f₀ is the effective distance between the position detector and lens.

Similarly, in a 2 or 3-D imaging system, changes in the range direction of the surface as the surface is scanned laterally also results in movement of the spot image along the array. Thus, by reading the position of the spot on the detector array, the range profile of an object can be determined.

To obtain range information as a function of lateral position, the projecting laser beam may be scanned in the x and y directions and the range measured at different positions in the scan. The detector array may be moved with the scanning projected beam, so that changes in the position of the beam at the detector array are only attributable to changes in the range. Typically, the whole optical system including the laser source and detector are mounted on a pan-tilt unit which allows the projected beam to be steered in the x and y directions.

In comparison to the co-aligned LIDAR systems of FIGS. 1 and 2, the triangulation-based LIDAR systems of FIGS. 3 and 4 do not suffer from the dynamic range problem to the same extent, as the beam is continuous rather than pulsed and the measurement relies on the position of the return beam at the detector, rather than the time difference between launched and received pulses. However, unlike the systems of FIGS. 1 and 2, which can incorporate a relatively high speed, 2-axis optical scanner, the pan-tilt scanning mechanism used in triangulation-based LIDAR systems can only achieve relatively slow scan rates.

Examples of a 3-dimensional imaging system are described in U.S. Pat. No. 4,627,734, by Rioux (the entire content of which is incorporated herein by reference), and a physical implementation of a 3-dimensional laser camera which is based on one of these examples is shown in FIG. 5. Referring to FIG. 5, the imaging system 100 comprises a laser source 103, a collimator 105 for collimating the laser beam, x and y scanning mirrors 107, 109 for scanning the projected beam in the x and y directions, respectively, first and second, fixed side mirrors 111, 113, y and x-scanning receiving mirrors 115, 117, a collection lens 119 and a position detector 121. In operation, the collimated laser beam 123 from the collimator is directed onto the x-scanning mirror 107 via a fixed mirror 125 and a through hole 127 formed in the y-scanning mirror 109. The x-scanning mirror 107 reflects the beam onto the first fixed side mirror 111. The side mirror 111 reflects the beam onto the y-scanning mirror 109 which subsequently projects the beam onto a surface 129 to be imaged. The beam 131 reflected from the surface 129 is first received by the receiving y-scanning mirror 115, then reflected onto the second fixed side mirror 113 and onto the receiving x-scanning mirror 117. The receiving x-scanning mirror 117 reflects the collected beam onto the detector 121 via the collection lens 119. The x and y coordinates of the beam position at the surface are determined from the angular position of the x- and y-scanning mirrors, and the z-coordinate (or range) of the surface is determined from the position of the collected beam on the position sensitive detector 121. In this arrangement, the projected and reflected beams are scanned simultaneously, without the need to physically move either the source or detector. Furthermore, the beams are scanned in such a way that scanning a planar surface positioned orthogonal to the range direction results in nil change in the position of the beam at the detector. Thus, the position of the beam on the detector provides only range information.

Most 3D active triangulation systems project collimated circular beams or collimated line beams on the target object, and in most applications, a beam size of 1 mm is used to minimize the beam divergence over the entire range distance. With a beam size of 1 mm, the lateral resolution (x, y-direction) is normally on the order of a millimeter.

An example of an integrated Time-of-Flight and Triangulation laser scanning system is described in F. Blais, J.-A. Beraldin, S. F. Hakim, “Range Error Analysis of an Integrated Time-of-Flight, Triangulation, and Photogrammetry 3D Laser Scanning System,” SPIE Proceedings of AeroSense, Orlando, Fla., Apr. 24-28, 2000, Vol. 4035. The system comprises a single pulsed laser source, a scanning system for scanning the beam in the x and y directions, and a beam receiver, including an imaging lens, and a beam splitter for splitting the return beam into two beams, one of which is passed to a CCD detector for triangulation measurements, and the other is passed to a time-of-flight detector.

### SUMMARY OF THE INVENTION

According to one aspect of the present invention, there is provided an apparatus comprising beam generating means for generating first and second beams of energy, receiving means for receiving said first and second beams reflected from a target surface whose distance from said apparatus is to be measured, wherein the receiving means includes a detector for detecting the position of the reflected first beam at said apparatus, wherein said position is dependent on the angle between the incident and reflected first beam and thereby the distance between said apparatus and the position from which said first beam is reflected from said surface.

According to another aspect of the present invention, there is provided an apparatus comprising projection means for projecting first and second beams towards a target surface, and receiving means for receiving beam energy reflected from the target surface.

Advantageously, the use of two beams facilitates measuring the position of the target surface using two measurement devices which may use either the same or different measuring techniques. In one embodiment, one of the two beams is used to measure the position of the object using a triangulation technique and the other beam is used to measure the position of the target surface using another technique, for example, a time of flight technique.

In one embodiment, the first and second beams have a parameter whose value for the first beam is different to that of the second beam. For example, the two beams may have different wavelengths. This facilitates detection of the beams at the receiver side.

The provision of at least two beams also allows the beams to be controlled independently. For example, one beam could be pulsed and the other continuous. In another example, the beams may have different sizes. The beams may have different characteristics along their beam path. For example, one beam may have a different convergence from the other or a different divergence to the other or one beam may be collimated and the other divergent or convergent. On the other hand, both beams may be collimated and have either the same or different sizes. Advantageously, this allows the beam size to be tuned for different range measurements. For example, the triangulation method is particularly applicable for short-range measurements and time of flight is particularly suited to long range measurements.

The use of two beams also facilitates detecting the beams simultaneously and making position measurements using the two beams at the same time, for example, in the overlap region between two different ranges of measurement. The use of two separate beams also allows the power of each beam to be set individually, and the power of one or both beams may be variable.

In another aspect and embodiment of the invention, the beam generator may be adapted to generate first and second beams at different times, so that only one beam is generated at any one time. In this aspect, the beam generator may be adapted to generate first and second beams each having a different characteristic, e.g. wavelength, to facilitate detection of each beam, for example by different detectors.

In some embodiments, one or more beams may be launched using a waveguide such as an optical fiber.

In some embodiments, the second beam may be transmitted to a detector using a waveguide such as an optical fiber.

In some embodiments, the apparatus includes a device for receiving the beam energy of the first beam and passing the beam energy to the detector. The device may comprise an imaging device having an optical aperture for directing first beam radiation onto the detector at a position which depends on the angle between the incident and reflected first beam radiation. The device may for example comprise a focusing device such as one or more lenses, or one or more simple apertures.

In some embodiments, the receiving means or receiving system comprises separating means for spatially separating the reflected first and second beams. For example, the separating means may comprise a filter which separates the two beams spatially according to a particular characteristic which is different from one beam to the other. For example, if the wavelengths of the beams are different, the filter may comprise a dichroic filter. Advantageously, the provision of a dichroic filter may reduce beam attenuation in comparison to other devices such as beam splitters.

Advantageously, in some embodiments, both beams may be steered by the same steering mechanism and/or and both beams may share at least one component of the projection means or projection system and/or the receiving means or receiving system.

In some embodiments, the projection system is arranged so that the first and second beams are transmitted substantially in the same direction. Both beams may also be arranged so that they overlap or are co-located (i.e. coincident with one another). A filter such as a dichroic filter may be provided in the projection system for combining the two beams, or the beams may be combined by any other means or arrangement.

In some embodiments, the receiving system comprises means for redirecting the second beam towards an input of a receiving device. In one embodiment, this may be provided by a diffuser for diffusing the beam or, for example, by a diffractive optical element. The diffractive optical element may be arranged to spread the beam along a line path, for example, or may spread the beam into any other geometrical pattern.

In some embodiments, the receiving section or system may further include a beam power regulator for regulating the power of at least one of the first and second beams. In some embodiments, the power regulator may be provided by a diffractive optical element which directs the beam in a plurality of different directions with the power being direction dependent. Advantageously, this allows the power of the beam to the detector to be controlled to maintain a reasonable dynamic range, for instance. For example, the device may operate such that when the beam has a high power, the device attenuates the beam more than when a low power signal is received.

In any embodiment, the projection system may comprise an x and/or y scanning device. A reflector device may be arranged to reflect a beam from one scanning device to the other.

In any embodiment, the receiving system may comprise an x and/or y scanning device. A reflector device may be arranged to reflect a beam from one scanning device to the other.

In any embodiment, a driver means may be arranged to drive movement of an x-scanner of the projection system and receiving system synchronously.

In any embodiment, a driver means may be arranged to drive movement of a y-scanner of the projection system and receiving system synchronously.

Other aspects and embodiments of the invention comprise any feature disclosed or claimed herein in combination with any one or more other feature disclosed or claimed herein or their equivalent generic or otherwise.

### BRIEF DESCRIPTION OF THE DRAWINGS

Examples of embodiments of the present invention will now be described with reference to the drawings, in which:

FIG. 1 shows a schematic diagram of a conventional co-aligned LIDAR optical system;

FIG. 2 shows a schematic diagram of another example of a conventional co-aligned LIDAR optical system;

FIG. 3 shows a schematic diagram of a triangulation-based LIDAR system;

FIG. 4 shows a schematic diagram of a conventional triangulation-based LIDAR system;

FIG. 5 shows a plan view of a laser camera system according to the prior art;

FIG. 6 shows a schematic diagram of an apparatus according to an embodiment of the present invention;

FIG. 7 shows a schematic diagram of an apparatus according to another embodiment of the present invention;

FIG. 8 shows a perspective view of the embodiment shown in FIG. 7;

FIG. 9 shows a schematic view of an apparatus according to another embodiment of the present invention;

FIG. 10 shows a schematic view of an apparatus according to another embodiment of the present invention;

FIG. 11 shows a simplified geometrical model of an embodiment of the apparatus;

FIG. 12 shows an example of a diagram of returned beams having focal points at different locations depending on the range of a target object;

FIG. 13 shows a side view of a detection system according to an embodiment of the invention;

FIG. 14 shows a side view of a detection system according to another embodiment of the present invention;

FIG. 15A shows a side view of a detection system according to another embodiment of the present invention;

FIG. 15B shows a cross-sectional side view of an optical fiber having a transmission coating;

FIG. 16 shows a schematic diagram of a detection system according to another embodiment of the present invention;

FIG. 17 shows a schematic diagram of an embodiment of a beam generator for use in embodiments of the apparatus; and

FIG. 18 shows a schematic diagram of another embodiment of a beam generator for use in embodiments of the apparatus.

### DESCRIPTION OF EMBODIMENTS

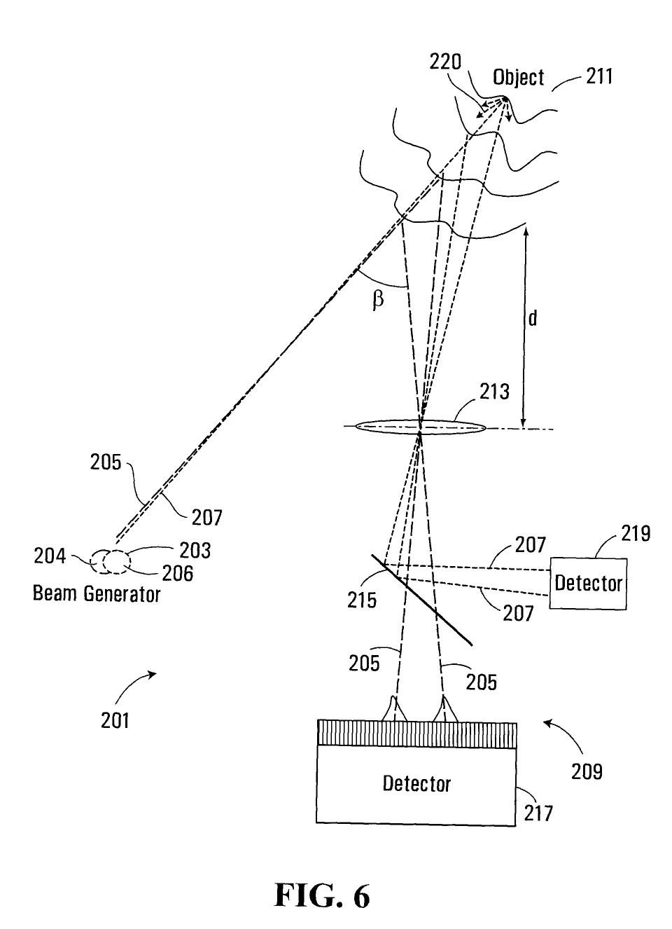

FIG. 6 shows an apparatus according to an embodiment of the present invention. The apparatus 201 comprises a beam generator 203 for generating first and second beams of energy 205, 207 and a receiving system 209 for receiving beam energy from the first and second beams reflected from an object 211 spaced from the apparatus. In this embodiment, the receiving system comprises a collection lens 213 for receiving beam energy scattered from the object and for imaging (e.g. focussing) the received beam energy, a beam separator 215 for spatially separating the first and second beams 205, 207 reflected from the object, and first and second detectors 217, 219 for detecting the first and second beams, respectively. It will be appreciated that for a diffuse surface, the incident beams will be scattered by the surface as shown by the ray lines 220, for example, and a portion of the scattered radiation will be received and imaged by the lens 213 (or other device). It is this portion of the scattered radiation which is referred to herein as beams reflected from the object, although, generally, the radiation is scattered in other directions. A ray which passes through the center of the lens will be transmitted without refraction to the detector, i.e. the ray will be transmitted in a straight line from the object to the detector through the lens. Rays from the same point on the object scattered at different angles and which are received by the lens will be focussed by the lens and the focal point may coincide with the detector.

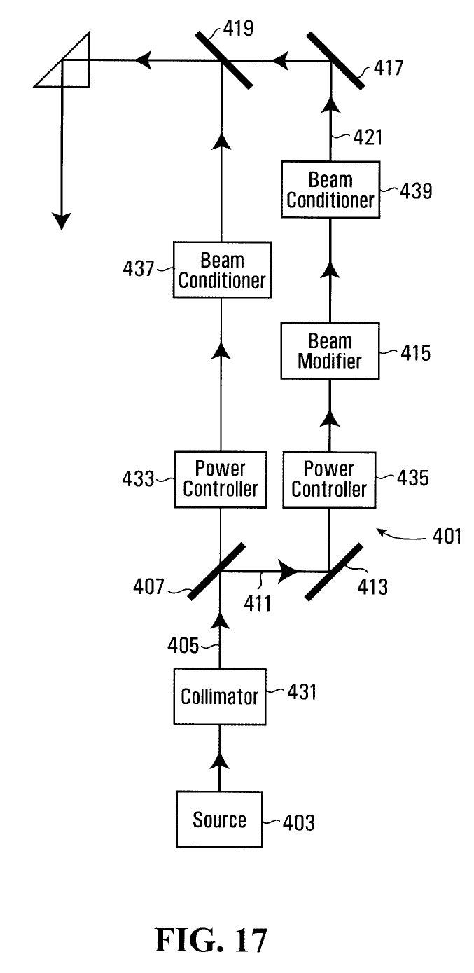

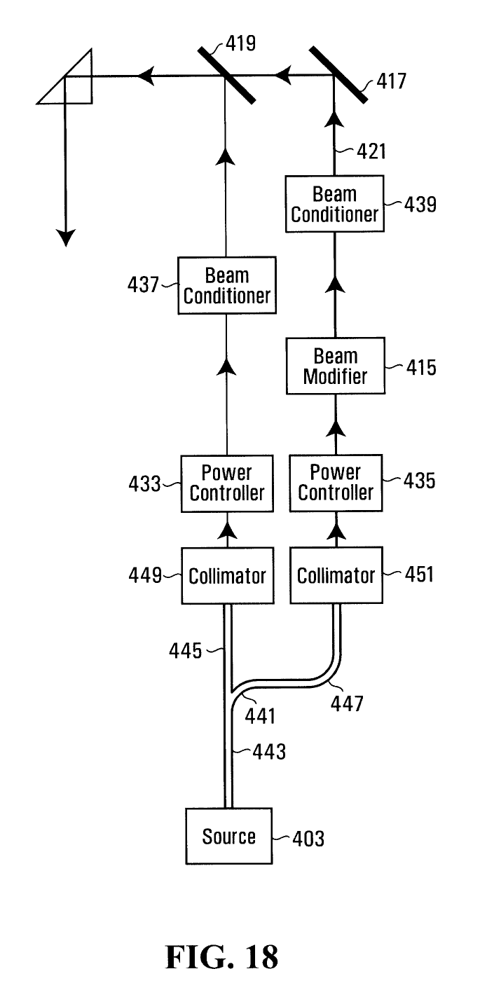

In this embodiment, the first and second beams 205, 207 comprise coherent electromagnetic radiation which may, for example, be generated by a laser. In other embodiments, the first and/or second beams may comprise other forms of radiation or energy, for example, non-coherent electromagnetic radiation. In this example, the first and second beams 205, 207 are generated by two separate lasers 204, 206 and the two beams have different frequencies and wavelengths to assist in discriminating between the two beams at the receiver side. In other embodiments, both beams may be generated initially from a single beam using a suitable arrangement such as a beam splitter and frequency modifier, examples of which are described below with reference to FIGS. 17 and 18.

In the present embodiment, the first laser beam 205 comprises a continuous wave laser beam and is used to make measurements based on the triangulation method, whereas the second beam 207 comprises a pulsed beam and is used to make distance measurements based on a measurement of the time taken for the beam to travel between the apparatus and the target object.

The two projected beams may be directed generally along the same path, as for example shown in FIG. 6, so that both beams intercept the target object surface at substantially the same location. In this arrangement, both methods can measure the range to substantially the same point or part of the object.

In the receiving system, the beam separator 215 separates the first and second beams reflected from the target object according to their frequency, and may comprise, for example, a dichroic filter. In the present arrangement, the dichroic filter is arranged to pass the first beam 205 onto the detector 217 and to reflect the second beam 207 for transmission to the second detector 219.

The first detector 217 comprises a position detector for detecting the position of the reflected first beam 205, and in one embodiment, the position detector may comprise an array of sensors for sensing the first beam, such as photosensitive detectors.

The second detector 219 comprises a time of flight detector for measuring the time between launched and received pulses of the second beam 207.

Advantageously, the system enables the distance (e.g. ‘d’) between the apparatus and a target object to be measured for both long and short range distances, and allows the distance to be measured continuously as the distance changes from long to short range or vice versa.

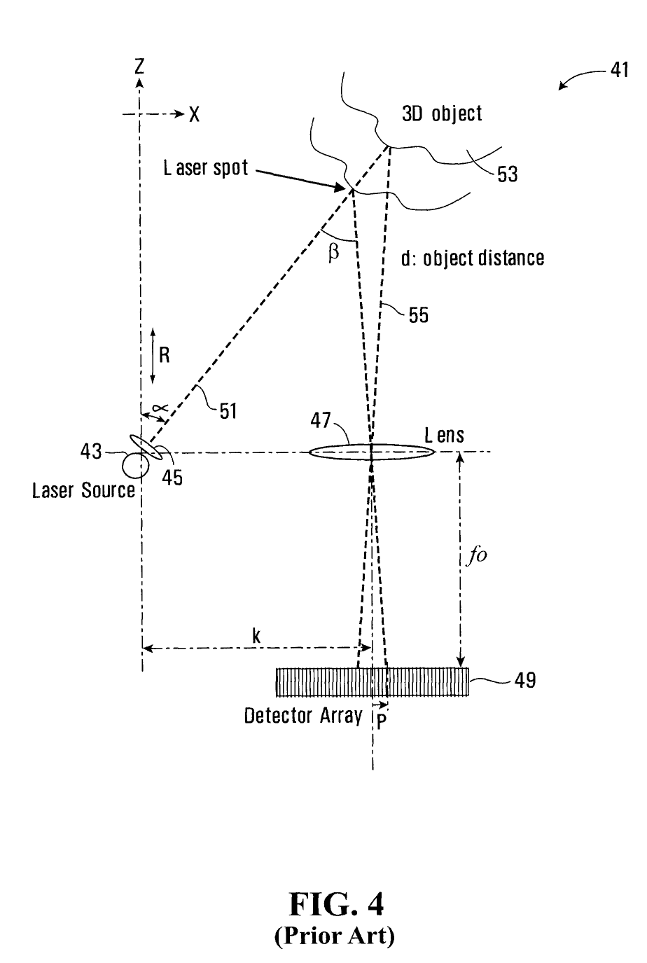

In operation, short range measurements are made using the first beam 205 and first detector 217 based on the triangulation method. In this method, the angle β between the projected and reflected beams, and therefore the position of the reflected beam on the first detector 217, depends on the distance between the apparatus and the surface of the target object from which the beam is reflected, as shown in FIG. 6. Therefore, the distance between the apparatus and the target object can be determined mathematically from the position of the reflected beam at the detector (using, for example, the trigonometrical relationships described above with reference to FIG. 4).

Long range measurements are made using the second beam 207 and second detector 219 based on the time between launched and received pulses.

The distance can be measured simultaneously using both techniques and the measurement from either technique can be selected, as appropriate, depending on, for example, the accuracy of the technique for the particular distance. Since both techniques can work simultaneously, distance measurements can be made continuously as the distance to the target object decreases from long to short range or increases from short to long range. Depending on the specific implementation, embodiments of the instrument may be adapted to allow distance measurements to be made continuously from several kilometers to 1 mm or less.

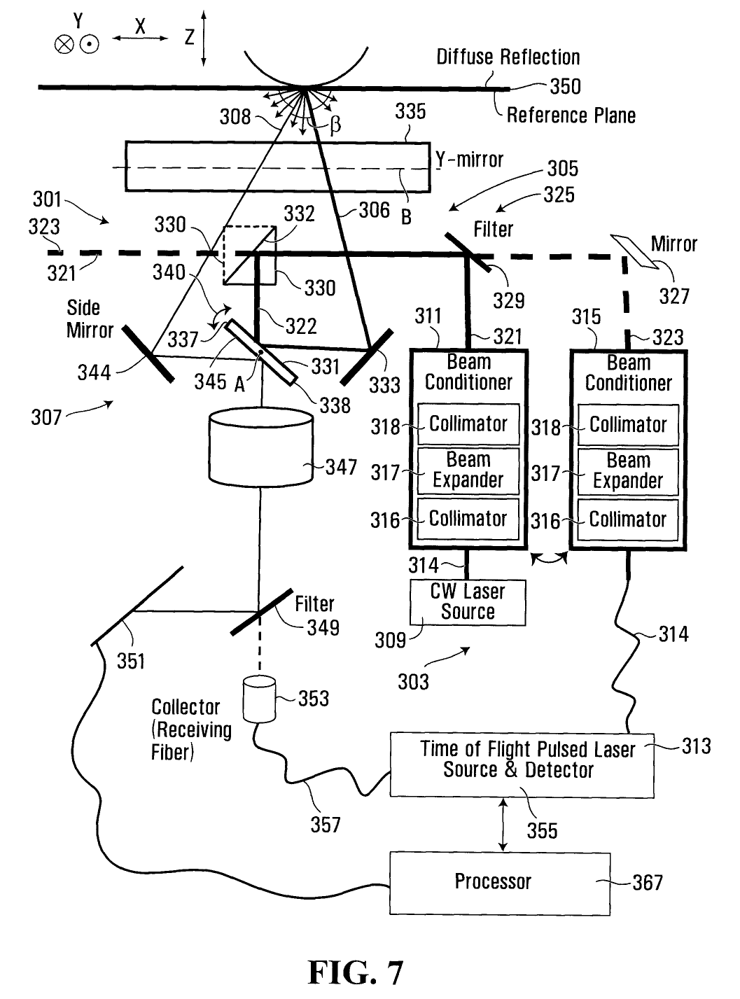

The embodiment shown in FIG. 6 is primarily arranged to make one-dimensional measurements, i.e. the distance between the apparatus and a target object or the position of the target object relative to the apparatus. In other implementations, the apparatus may be adapted to scan the surface of an object to provide information about its surface structure and for this purpose, the apparatus may be adapted to scan one or both beams in either or both lateral directions (i.e. the x and/or y directions). Examples of implementations which allow the beams to be scanned in both lateral directions are described below with reference to FIGS. 7 to 11.

Referring to FIGS. 7 to 10, a tracking or range measurement apparatus 301 according to an embodiment of the present invention broadly comprises a beam generating portion 303, a beam steering portion 305 for controlling the direction of the projected or incident beam 306 and a beam receiving and detection portion 307 for receiving and detecting the reflected beam 308.

In this embodiment, the beam generating section 303 comprises a first laser source 309 for generating continuous coherent electromagnetic radiation, which may or may not be in the optical spectrum, and a first beam conditioner 311 for conditioning the laser radiation, and which may comprise a collimator 316 coupled to receive and collimate the continuous wave radiation from the first laser source 309 into a collimated beam.

The laser source may be any suitable laser source. For example, the laser source may include a laser and single mode (SM) optical fiber 314 which produces a divergent beam, which is subsequently collimated by the beam conditioner 311. In another example, the laser source may generate a collimated beam (e.g. as provided by a HeNe laser), in which case, the beam conditioner 311 may be omitted.

The beam generating portion 303 further comprises a second laser source 313 for generating pulsed coherent electromagnetic radiation which may or may not be within the optical spectrum, and a second beam conditioner 315 for conditioning the laser beam. Laser radiation is transmitted from the source to the beam conditioner via an optical fiber 314 which outputs a divergent beam. The beam conditioner comprises a collimator 316 coupled to receive the laser radiation, from the optical fiber 314, a beam expander 317 coupled to receive and expand the collimated beam 316 from the collimator 316, and a second collimator 318 for collimating the expanded beam.

The two laser beams 321, 323 output from the first and second beam conditioners 311, 317, respectively, are introduced to the input 325 of the beam steering section 305.

In this embodiment, the wavelength of radiation in the first beam 321 is different from the wavelength of radiation in the second beam 323 and this assists in discriminating between the two beams in the detector section, as described in more detail below. In this particular example, the wavelength of the first beam is 1500 nm and the wavelength of the second beam 323 is 905 nm, although in other embodiments, the wavelength of the first and/or second beam may be any other value.

In this embodiment, the first beam 321 is provided for making measurements using the triangulation method, which is particularly suited for short-range distance measurements, and the second beam 323 is provided for making time of flight measurements which is particularly suited to long-range distance measurements.

The beam expander 317 of the second beam conditioner 315 can be selected to expand the beam from the collimator to a size which reduces beam divergence and allows the beam to remain collimated over a longer distance to extend the range over which objects can be detected and their distance measured.

Advantageously, the provision of an independent beam conditioner (e.g. collimator 311) for conditioning the first beam allows the size of the first beam 321 to be determined and/or controlled independently of the size of the second beam, so that the beam size can be optimized for triangulation-based distance measurements. Typically, for short-range measurements, the first beam is a collimated beam having a smaller diameter than the second beam. For example, in one embodiment, the diameter of the second beam 323 may be 20-30 mm, e.g. 25 mm, and the diameter of the first beam 321 may be between 4 and 10 mm, for example 6 mm.

In some embodiments, the beam expander of the second beam conditioner 315 may comprise a fixed beam expander, and in other embodiments, the beam expander may comprise a controllable expander to allow the beam width to be varied.

In some embodiments, the first beam conditioner 311 may be such that the width of the output beam is fixed, or variable. To implement this latter feature, further means such as a variable beam expander or other optical device may be provided to enable the width of the first beam 321 to be varied.

In some embodiments, focussing means such as a lens device may be used to focus the first beam 321 onto the object being measured to increase the accuracy of detection of a particular feature on the object and to increase the resolution of the measured distance between the apparatus and a particular point on the surface of the object. The lens device may allow the focal length of the first beam 321 to be varied or the lens may be a fixed lens. Some embodiments may include means for generating a relatively wide beam and a focusing device for focusing the wide beam onto the target object to a relatively small size of for example less than 1 mm, e.g. 500 nm or less, to increase the resolution of distance and lateral measurements for imaging. Examples of an apparatus for achieving higher resolution measurements are disclosed in the applicant's co-pending International (PCT) application filed on 9 Aug., 2006, under attorney docket number 51188-14, which claims priority from U.S. Provisional Application entitled “Imaging System and Method” filed on 2 Sep., 2005, under Attorney Docket No. 51188-11.

Returning to FIGS. 7 to 10, in this embodiment, the apparatus further comprises a preliminary mirror 327 for receiving the second beam 323 from the beam conditioner 315, and which is angled thereto for reflecting the beam towards the input 325 of the beam steering section. In this embodiment, the preliminary mirror 327 is mounted at an angle of 45° to the incident beam to turn the beam through 90°, although in other embodiments, the preliminary mirror 327 may be mounted at any other angle. The apparatus further comprises a wavelength selective filter 329 which is adapted to pass the second beam 323 from the preliminary mirror 327 and reflect the first beam 321 from the beam conditioner 311. In this embodiment, the filter 329 is angled at 45° relative to the direction of the first beam 321 from the beam conditioner 311 to turn the first beam through 90° into the beam steering section. This arrangement allows the first and second beams to be introduced into the beam steering section so that the beams are parallel and close to one another. In the embodiments of FIGS. 7 to 10, the arrangement is such that the first and second beams are introduced into the beam steering section as coaxial or coincident beams, so that both beams can be directed along the same line towards an object. Although in other embodiments, the beams may be non-coincident or spaced apart, arranging the beams to be coincident with each other potentially simplifies the beam steering mechanism and allows the mechanism to be more compact. Furthermore, using coincident beams enables the distance to the object as measured by the time of flight and triangulation methodologies generally to be measured from the same or similar position on the object which may be beneficial when comparing the results of the two methods when the distance to the object is in the transition region between long and short range.

The beam steering section 305 comprises a prism 330, a first movable mirror 331, for moving the beams along the x-axis, and which hereinafter is referred to as the “x-mirror”, a first side mirror 333 and a second movable mirror 335, for moving the beams along the y-axis and which hereinafter is referred to as the “y-mirror”. The rear face 332 of the prism is reflective and may comprise for example a coating of reflective material. The reflective material, in one example comprises aluminum, although any other suitable reflective material could be used. In another embodiment, the prism may be replaced by a plate of transparent material having planar front and rear surfaces with the rear surface made reflective, by, for example, providing a suitable coating thereon.

The prism 330 is arranged to receive the first and second beams 321, 323 and turn and reflect the beams onto the x-mirror 331. In this embodiment, the x-mirror is rotatable about an axis “A”, which generally extends along the y-direction in the plane of the mirror between the opposed side edges 337, 338 thereof, i.e. generally perpendicular to the page containing FIG. 7, so that the mirror can rotate in either direction as indicated by the arrows 340. The x-mirror 331 directs the first and second beams onto the first side mirror 333 which subsequently reflects the beams onto the y-mirror 335. The y-mirror is rotatably mounted about an axis “B” which extends along the x-direction, and is therefore orthogonal to the axis of rotation “A” of the x-mirror 331.

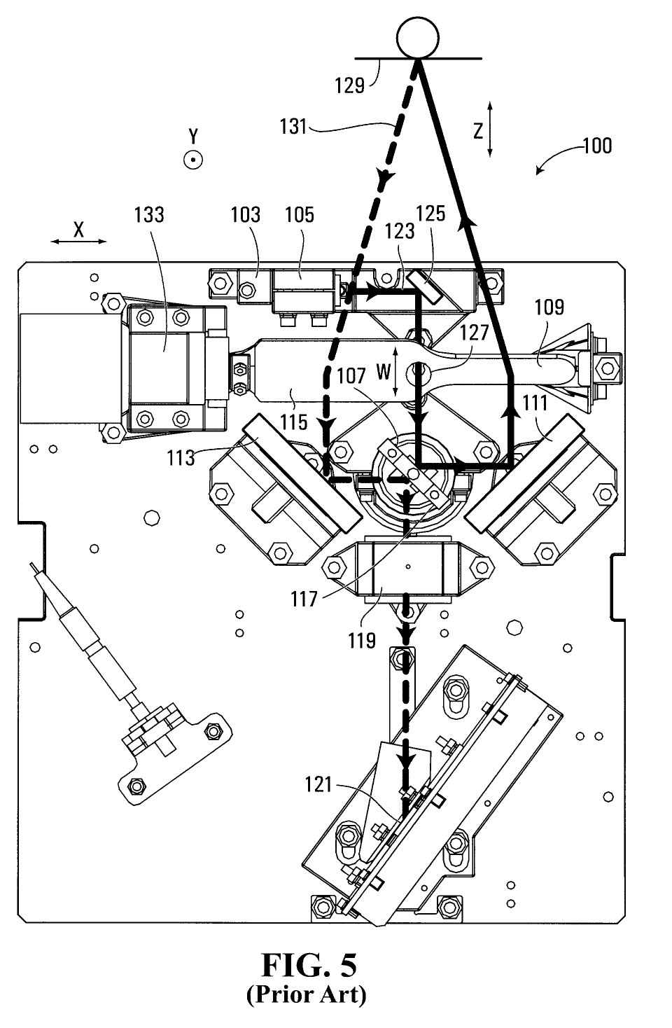

In contrast to the apparatus shown in FIG. 5, in which the beam is introduced into the beam steering system through a hole in the y-mirror, in the present arrangement, the beams are introduced from the side between the x- and y-mirrors, and in this embodiment, generally along the direction of the length of the y-mirror or its rotational axis B. Advantageously, this obviates the need for a hole in the y-mirror, and also allows a beam of relatively large size to be introduced into the beam steering section. The use of a larger beam width potentially extends the range over which objects can be detected and their distance measured. The use of a prism to reflect the beam onto the x-mirror enables a relatively large beam to be used. The prism also provides a compact reflective element without structure behind the reflective surface which might otherwise interfere with the beam and reduce the field of view. In another embodiment, the beams may be introduced from the left-hand side, rather than the right-hand side, as shown by the broken line 321, 323 in FIG. 7. In this case, the prism, or other reflector device, may be rotated through 180° relative to that shown in FIG. 7, as shown by the broken lines. In yet another embodiment, the prism 330 may be oriented so that the exterior surface of the hypotenusal side faces the incident beams from the beam sources, again as shown by the broken lines in FIG. 7. Thus, in this alternative arrangement, the prism is also effectively rotated through 180°.

In general, the beams are introduced into the beam steering section along a plane which is generally transverse to the direction of the spacing between the x and y scanners (e.g. mirrors 331, 335). In another embodiment, the beams may be introduced at any angular position about the beam (axis or line) 322 between the device 330 and the x-scanner 331.

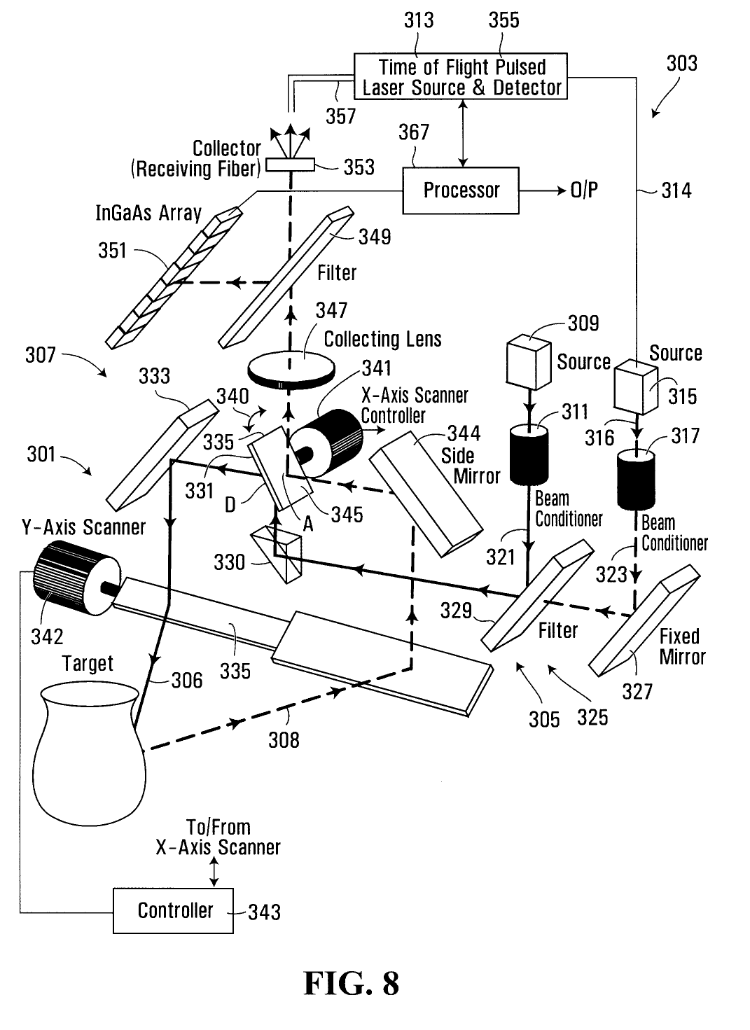

In operation, the x-mirror allows the beams to be steered laterally along the x-direction and the y-mirror allows the beam to be steered laterally in the orthogonal, y-direction (through the page in FIG. 7), so that together, the x- and y-mirrors allow the beams to be steered in two dimensions. Rotation of the x and y mirrors may be driven by any suitable means. In one embodiment, at least one or both mirror(s) is driven by an electric motor or galvanometer which allows the angle of the mirror to be moved quickly to any desired angle. This allows the beam direction to be selected arbitrarily. In the present embodiment, both mirrors are driven by a respective galvanometer 341, 342, as shown in FIG. 8.

The x and y-mirror drivers 341, 342 may be controlled by a controller 343, as shown, for example, in FIG. 8, and which may include a user interface for receiving user input commands for controlling the beam direction.

The receiving and detection section 307 comprises a second side mirror 344, a second movable x-mirror 345, an optical device 347, a second filter 349, a first detector 351, a receiver or collector 353 and a second detector 355.

In addition to directing the projected beam towards an object, the y-mirror 335 also receives beam energy reflected from the object and reflects the beam energy onto the side mirror 344. As the device which controls the y scan of the projected beam and the device which receives the reflected beam are one and the same, i.e. the y-mirror, the y-scanner and receiver move (e.g. rotate) together and their movement is effectively synchronized. In other embodiments, the device which y-scans the projected beam and the device which receives the reflected beam may be separate devices, either joined together and driven by the same mechanism or the devices may be separate and driven by separate drivers in such a way that the movement of both devices is synchronized.

The second side mirror 344 is typically fixed (although its angle may be adjustable), and in the embodiment shown in FIGS. 7 to 10, the side mirror 344 is at an angle of 90° relative to the first side mirror 333.

The second movable mirror 345 is the x-scan receiving mirror, and in this embodiment is positioned on the opposite side of the x-scanning mirror 331. Thus, as for the y-mirror, the x-scanning mirror which receives the reflected beam is synchronized to the movement of the x-scanning projection mirror 331. Thus, the x and y scanning mirrors allow the beam to be steered and detected without needing to move either the beam source or the beam detectors. In other embodiments, the x-scan receiving mirror 345 may comprise a separate device from the x-scanning projection mirror 331 and both separate mirrors may be coupled in some other way so that their movement is synchronized. In one embodiment, the mirrors may each be driven by a separate motor which are controlled to synchronize the movement of both mirrors.

The optical device 347 may comprise a lens or an arrangement of two or more lenses, for example, a telescope, to focus the reflected beam energy onto the first detector 351. The filter 349 may comprise a wavelength selective filter, such as a dichroic filter, which reflects the received energy at the wavelength of the continuous wave laser onto the first detector 351, and passes the received energy at the wavelength of the pulsed laser to the collector or receiver 353.

In the triangulation method, the angle β between the incident and reflected beams is dependent on the distance of the object from the apparatus and as this angle changes, so does the position of the reflected beam on the detector 351. The detector 351 detects the position of the reflected beam and this information, together with the angular position of the x scanning mirror is used to determine the distance of the object. The detector 351 may comprise an array of detectors or sensors which are sensitive to the reflected beam wavelength. In one embodiment, the detector 351 comprises an array of InGaAs detector elements. The array may be mounted at an angle to the z-direction, so that the focal point of the return beam coincides with the surface of the array as the beam changes position, as for example shown in FIG. 7. The position of the peak beam energy on the detector may be used as the position for determining the distance, i.e. range, R, or z-coordinate. The beam steering system which steers both the projected and received beams is arranged such that any change in the lateral position of the beam on a reference plane (e.g. plane 350) orthogonal to the range or z-direction will result in nil change in the position of the reflected beam at the detector 351. In this case, only changes in range produce a change in the position of the beam at the detector.

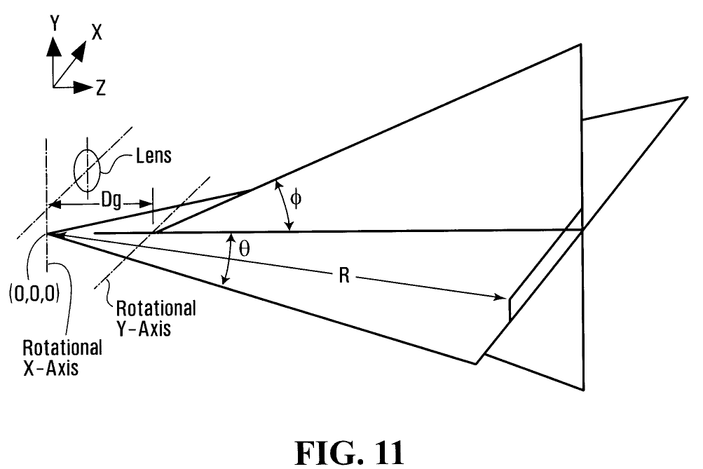

FIG. 11 shows a simplified geometrical model of an embodiment of the apparatus. Referring to FIG. 11, parameter, R, is the range and corresponds to a distance between the axis of rotation of the x-scanning mirror and a point, P, θ is the angle of rotation of the x-mirror and Φ is the angle of rotation of the y-mirror. As shown in FIG. 11, the rotational axis of the y-mirror is displaced from the rotational axis of the x-mirror by a distance Dg, and this displacement between the x and y axes results in an astigmatism so that θ, Φ and R are not real spherical coordinates. In a real spherical coordinate system, as implemented in a pan-tilt unit for example, the rotational axes of the x and y-mirrors cross at the origin where the light source is located.

In some embodiments, a signal provides a measure of the angular position of the x and y scanning mirrors and the signal may for example be x and y galvanometer voltages (u) and (v), respectively. The position of the beam at the detector may be provided by a signal indicative of the pixel number of a detected peak on the array (P). In order to obtain the x-mirror rotation angle θ, the y-mirror rotation angle Φ and the range R of an object as shown in FIG. 11, a white calibration board with black dots with known separation between the dots is placed in front of the apparatus at a known range location. By comparing images produced with u, v and P, as parameters, to the real range data and the angle between dots, a set of calibration parameters is produced, which can be used to convert u, v and P into θ, Φ and R values.

The quasi-spherical coordinates θ, Φ and R can be converted into Cartesian coordinates, x, y and z using the following equation which also corrects the astigmatism caused by the separation Dg of the x and y rotational axes:

$$[ \begin{matrix}x \\ y \\ z\end{matrix} ] = R \cdot [ \begin{matrix}sin ( θ ) \\ ( cos ( θ ) - ψ ) sin ( φ ) \\ ( 1 - cos ( φ ) ) Ψ + cos ( θ ) cos ( φ )\end{matrix} ]$$

$$where ψ = Dg / R .$$

This equation and additional details are described in Blais, F., Beraldin, J.-A., and El-Hakim, S. F., “Range error analysis of an integrated time-of-flight, triangulation, and photogrammetry 3D laser scanning system,” SPIE Proceedings of AeroSense, Vol. 4035, Orlando, Fla. April 24-28 (NRC 43649): SPIE, 2000.

Thus, the calibration process converts voltages (u, v) of the galvanometers that drive the x and y-mirrors and the peak location (P) on the detector array into Cartesian coordinates, x, y and z. This enables the apparatus to measure the three-dimensional location of any point of a target object.

In practice, there can be a small dependence of the position of the image on the detector on the x and y mirror position, which may be resolved by calibration using any suitable technique, for example, curve fitting, using a calibration look-up table, or by analytical calculation.

As mentioned above, energy received at the wavelength of the pulsed laser source is passed through the filter 349 and into a receiver 353 which is connected to the time of flight detector 355. Advantageously, the receiver 353 may transmit the received light to the second detector 355 through an optical fiber 357 to avoid losses between the receiver and detector.

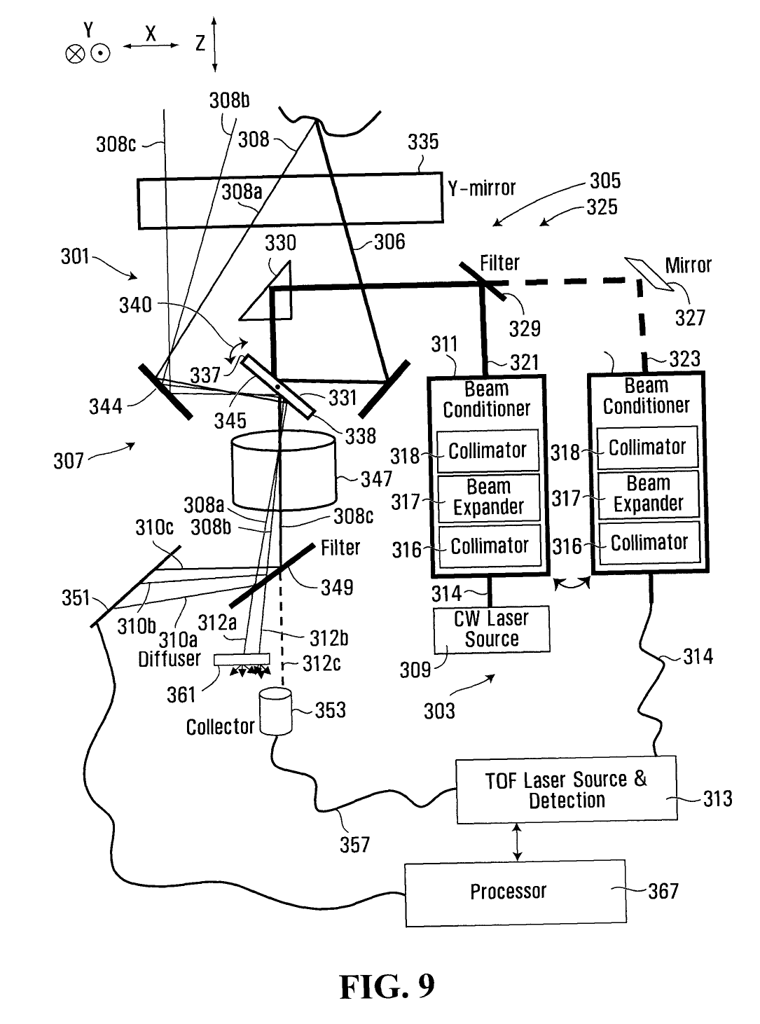

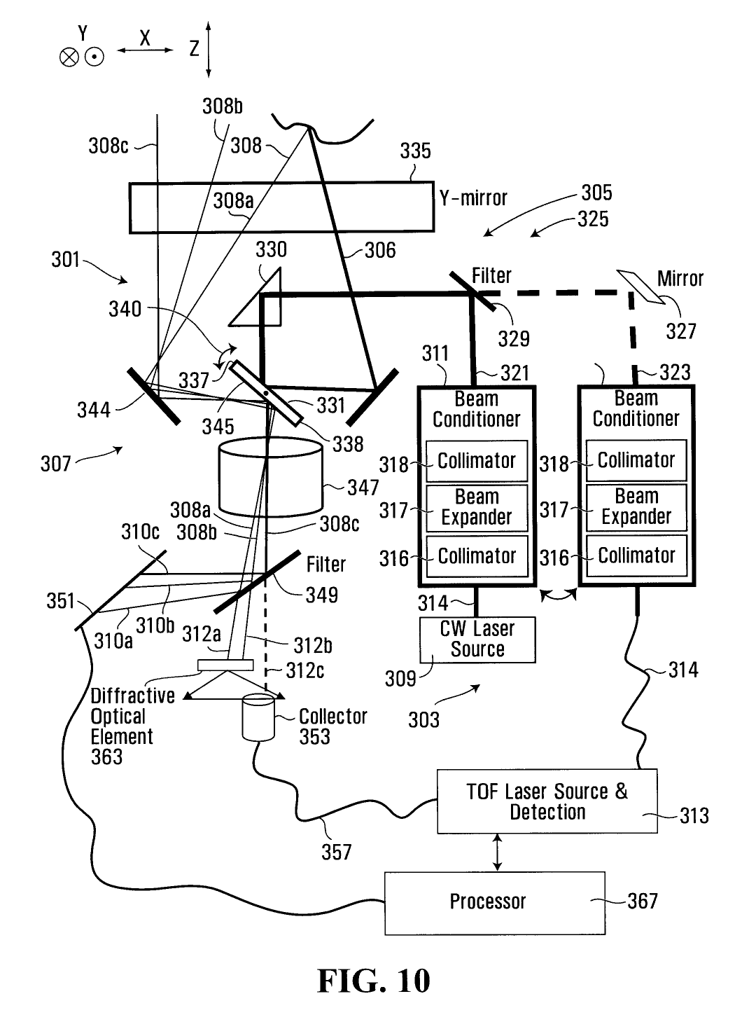

As illustrated in FIGS. 9 and 10, the trajectory of the reflected beam 308 from the collection lens 347 depends on the range (i.e. position along the z-axis) of the surface of the object from which the beam is reflected and the beam trajectory is measured by the position detector 351 to derive the range using the triangulation method. Likewise, the position of the return beam for time of flight measurements from the collection lens also changes with the range of the target object. The top of FIGS. 9 and 10 show three rays 308a, 308b, 308c reflected from the surface of a target object, for three increasing distances, respectively, between the object and the apparatus in the range direction. These different beam trajectories result in three different beam trajectories 308a, 308b, 308c from the collection lens 347 and the rays 310a, 310b and 310c of the first beam intercept the position detector at three different positions. Similarly, the trajectory of the ray 312a, 312b and 312c of the second beam at the output of the beam separator 349 also varies with distance of the object from the apparatus in the range direction. Depending on the geometry and configuration of the apparatus, the position of the first beam at the position detector 351 may change by 12 mm or more as the range of the object varies. The x-position of the reflected second beam from the collection lens 347 may vary by a similar amount, and this variation presents a problem when introducing the beam into an optical fiber whose internal diameter is less than 1 mm. To solve this problem, in one embodiment, a diffuser 361 is positioned between the beam separator and the input of the optical fiber to intercept the beam and spread the beam laterally. In this case, although the beam trajectory is such that the beam from the beam separator is not aligned with the input of the optical fiber, energy from the beam will be redirected laterally by the diffuser so that a portion of the beam energy is incident on the input of the optical fiber. If necessary, the power of the beam may be adjusted to compensate for the beam attenuation caused by the diffuser.

In another embodiment, a diffractive optical element (DOE) also known as a holographic plate, may be used to redirect the reflected second beam into the optical fiber connected to the time of flight detector, and an example of such a configuration is shown in FIG. 10. A diffractive optical element 363 is adapted to generate a beam pattern when illuminated by a laser. These patterns include single and multiple line patterns, multiple dots, single square, dot matrix, single circle, concentric circles, and square grid patterns, as well as others. In the present embodiment, since the trajectory of the reflected second beam from the collection lens moves in one direction (e.g. the x-direction), a diffractive optical element which provides a single line pattern would be sufficient. However, in other embodiments, DOEs producing any other suitable pattern could be used. Other embodiments may include any other suitable device for spreading or directing beam energy laterally to introduce the beam into the optical fiber. In another embodiment, an array of beam sensitive detectors may be used to detect the reflected pulsed beam, although in some implementations, the capacitance of the array may result in a slow response time, making time of flight measurements more difficult.

A means of regulating the amount of beam input to the detector may be provided, for example, to maintain a reasonable dynamic range of the beam signal power. The regulator may be adapted to regulate the power as a function of beam position, which changes as a function of distance to the object. At short range, where the return signal is relatively strong, the regulator may be adapted to attenuate the beam more than at long-range where the power of the return signal is weaker. Advantageously, this, or any other regulation function may be provided by a diffractive optical element or other suitable device.

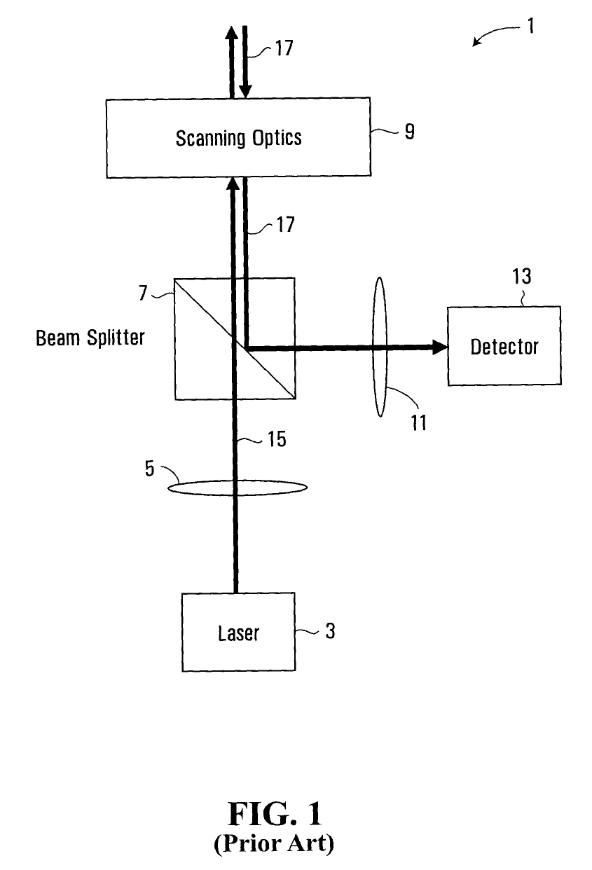

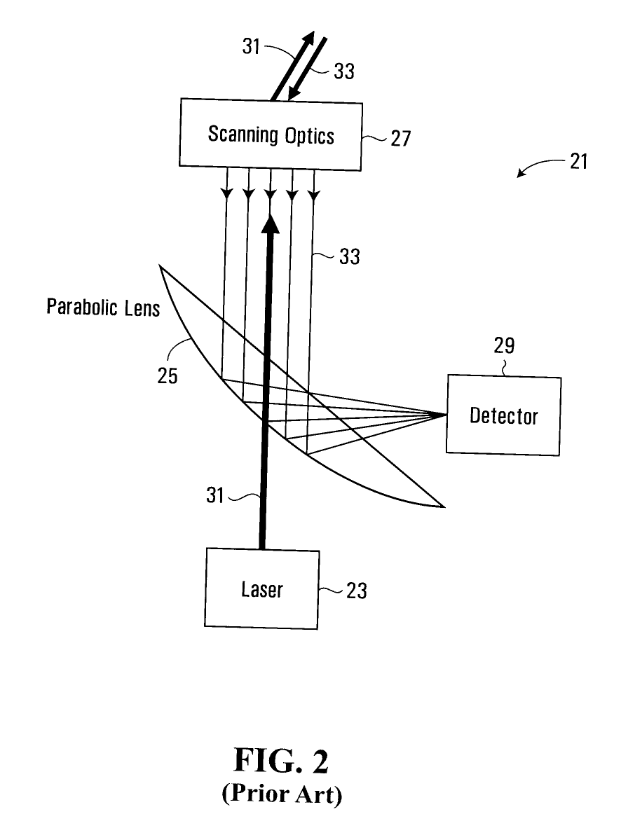

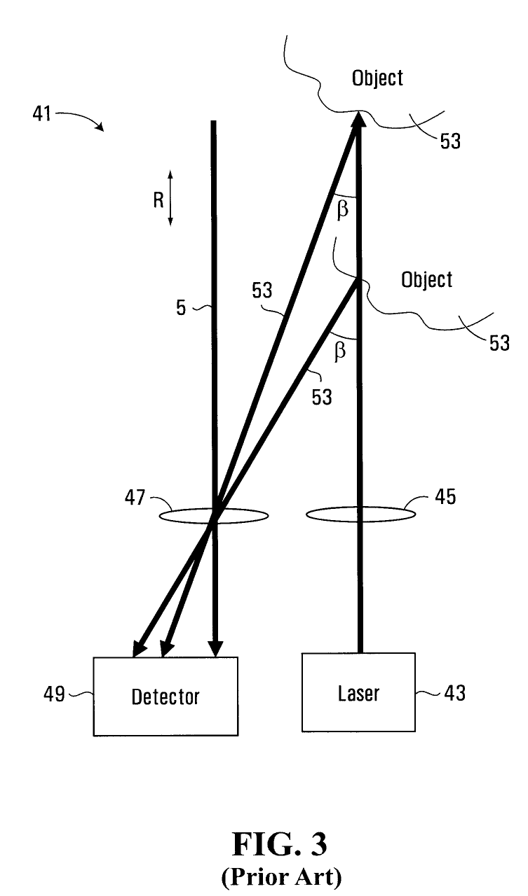

Embodiments of the apparatus provide a means of reducing the dynamic range required by a single detector to measure range by time of flight, thereby alleviating the problems associated with the conventional co-aligned and triangulation-based LIDAR systems described above with reference to FIGS. 1 to 4.

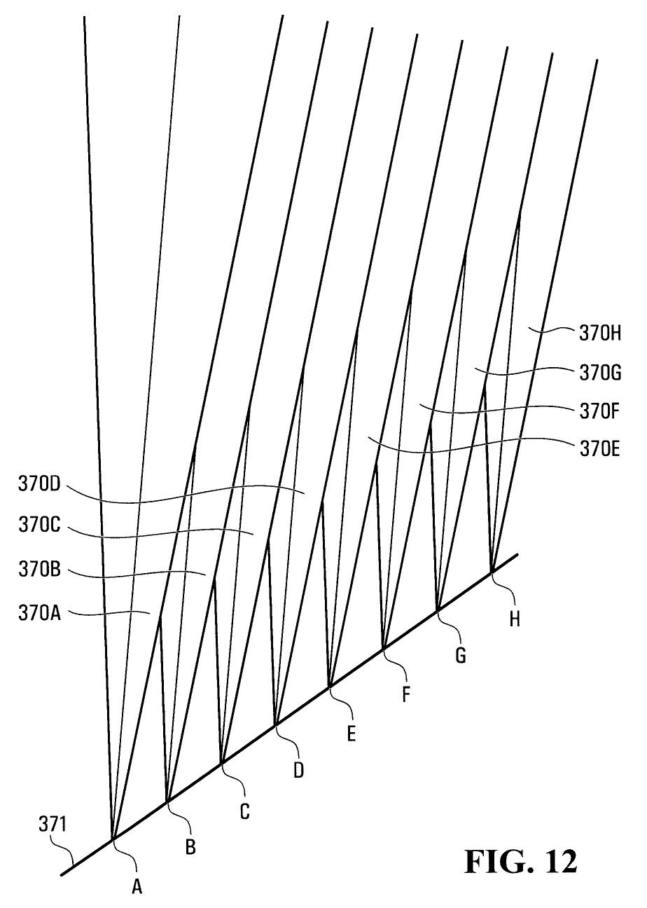

FIG. 12 shows a diagram of a number of returned optical beams 370A to 370H at different positions on a focal plane 371, and further illustrates the dependence of the location of the returned optical beam spot on the range of the target. In this example, as the distance to the target decreases, the returned beam moves from right to left, so for example, when the target is far, the beam returned from the target is focused on the right-hand side position of the focal plane and if the target is close, the returned beam is focused on the left-hand side position of the focal plane 371. Embodiments of the invention use this optical property to control the amount of light received by the time of flight detector to reduce the dynamic range requirement on the TOF electronics, and examples are described below. Advantageously, this enables the apparatus to detect objects over a wide range of distances within a reasonable dynamic range.

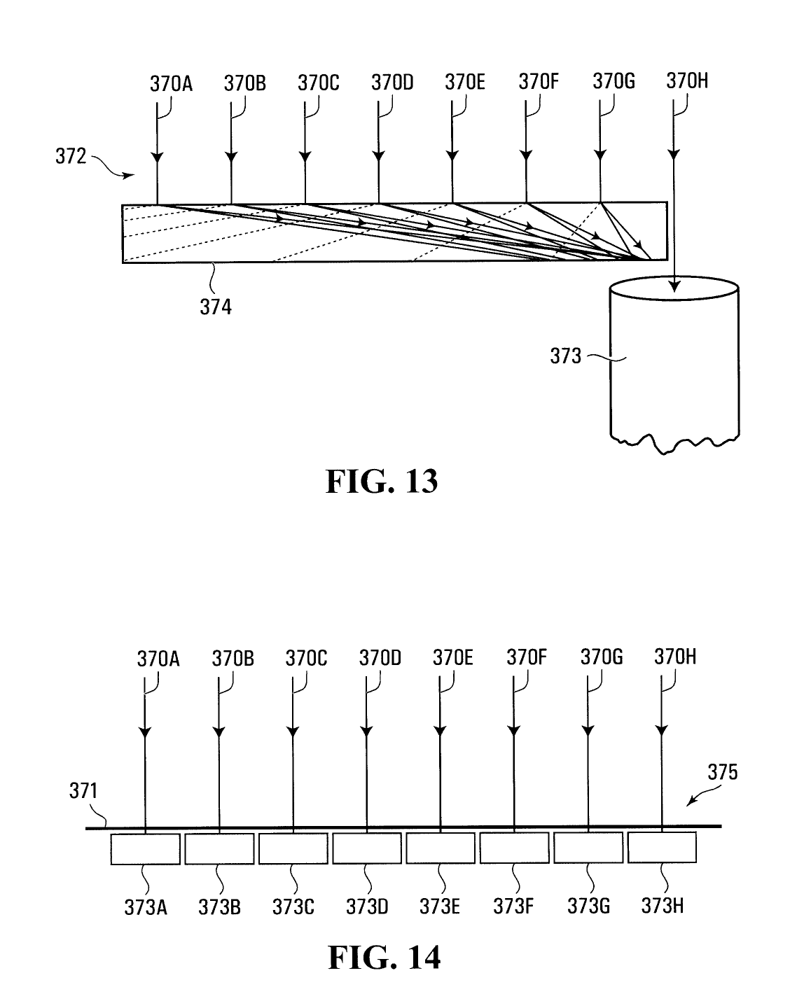

Referring to FIG. 13, a detection system 372 comprises a single receiver or detector 373 and a beam scattering device 374. The single receiver or detector is positioned to receive the most light from a far object (e.g. beam 370H) and the scattering device 374 is positioned to intercept and scatter light from beams returned from closer objects into the receiver or detector 373, and is similar to the arrangements shown in FIGS. 9 and 10. The scattering device 374 may be arranged so that progressively less light is scattered into the receiver or detector as the range to the object decreases. The scattering device 374 may comprise any suitable device for scattering electromagnetic energy, for example, a reflection or transmission diffuser or a diffractive optical element (DOE), as described above with reference to FIGS. 9 and 10.

Referring to FIG. 14, another embodiment of a detector system 375 comprises a plurality of detectors 373A to 373H which are positioned side by side in an array which extends along the direction in which the returned beam moves as the range varies. In one embodiment, the detectors may be arranged on the focal plane 371 of the returned beams, while in other embodiments, the detectors may be spaced from the focal plane. Each detector 373A to 373G has its own gain adjusted for the beam signal from different ranges. Thus, for example, where beams 370A and 370H are returned from relatively near and relatively far objects, respectively, detector 373A which receives beam 370A from a near object can be set relatively low, whereas the gain of the detector 373H which receives beam 370H from a relatively far range can be set relatively high. It will be appreciated that any number of detectors can be used in the array and the gain of one or more detectors may be the same as one or more other detectors, or the gains of each detector can be set to a different value.

In another embodiment, the detector system may comprise a plurality of beam receivers, such as receiving fibers, positioned side by side in an array along the direction in which the returned beam position changes with range, and the returned beam is transferred by the receivers to one or more detectors. For example, each beam receiver may be coupled to a respective detector, and the strength of the signals from different ranges is controlled by the gain of each detector, as for example described above with reference to FIG. 14. In another embodiment, the strength of the signals from different ranges is controlled by optical methods, examples of which are described below.

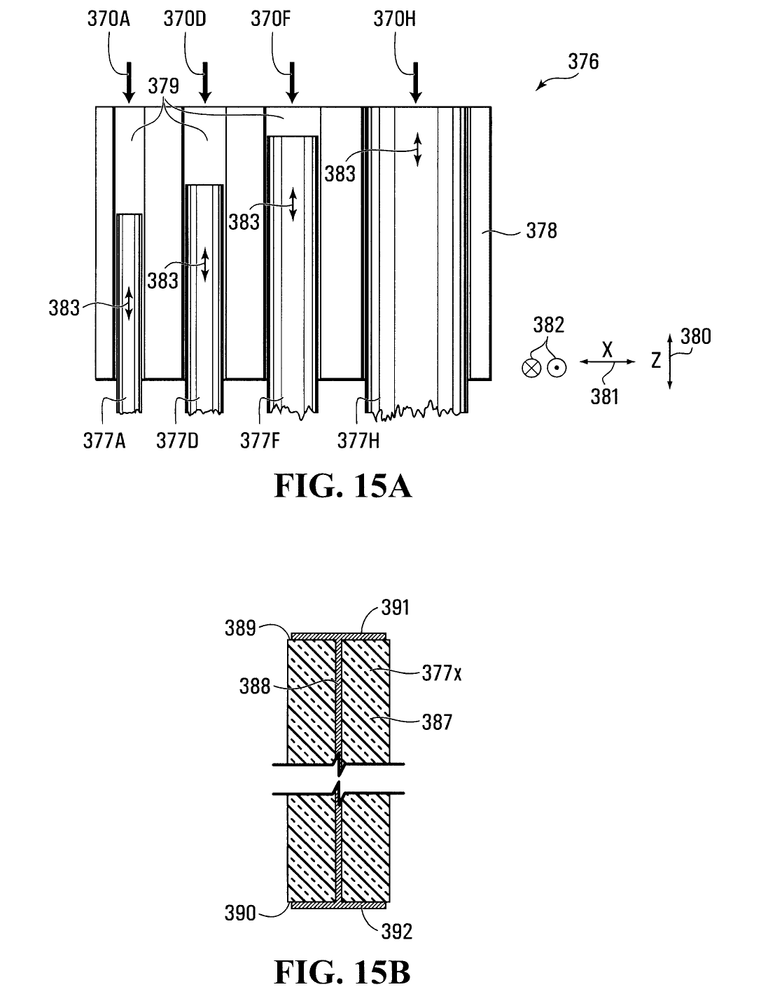

Referring to FIG. 15A, another embodiment of a detection system 376 comprises a plurality of beam collectors, e.g. optical fibers 377A, 377D, 377E, 377H positioned side by side in a linear array and mounted to a support structure 378. For example, the structure may comprise a mounting block having holes in which the beam receivers, e.g. fibers, are inserted. The amount of light received for each fiber can be controlled by (a) the fiber diameter, (b) a transmission coating on each fiber tip (or end), (c) the location of the fiber tip relative to the focal position of the returned beam, (d) providing an inline fiber attenuator, or (e) any combination of two or more of (a), (b), (c) and (d).

As shown in FIG. 15A, each receiving fiber has a different diameter, and the fiber with the largest diameter is positioned to receive beam energy from a beam returned from a relatively low range, whereas the fiber having the smallest diameter is positioned to receive beam energy returned from closer objects. Thus, less light will be accepted by the fibers having smaller diameters (entrance apertures) to reduce the signal strength from close objects and more light will be accepted by larger diameter fibers to increase the signal strength from far objects, both resulting in a reduction of the dynamic range.

In the embodiment of FIG. 15A, an end of each fiber may have a different coating to control the amount of light transmitted to a detector. For example, the fiber 377A which receives short range beam energy may have a coating which transmits less light than the coating of the fiber 377H which receives long range beam energy.

FIG. 15B shows an example of a fiber having an optical transmission coating in more detail. The fiber 377X has a fiber wall 387 defining a conduit 388 for the passage of light and opposed ends 389, 390. A transmission coating 391, 392 is provided at either one or both ends (or other position in the optical path) for controlling the amount of light (e.g. photon flux) transmitted to the detector.

The location of the fiber tips relative to the focal positions of the returned beam may be controlled, for example, by moving the fiber tips away from the focal point in the z-direction (beam direction) as shown for example by arrows 380, or by moving the fiber tips away from the focal point laterally, e.g. in a plane which is orthogonal to the z-direction, for example in the x or y direction as indicated by arrows 381, 382 in FIG. 15A. In the former case, each fibre may be moveable individually in the z-direction by allowing the fibre to slide relative to the mounting block 378, as indicated by arrows 383, or the fibres may be fixed to the mounting block and moved together by moving the block itself.

In one embodiment, the detection system 376 comprises a plurality of detectors, each coupled to a respective fiber. The gain of each detector may be the same or one or more detectors may have a gain that is different from one or more other detectors.

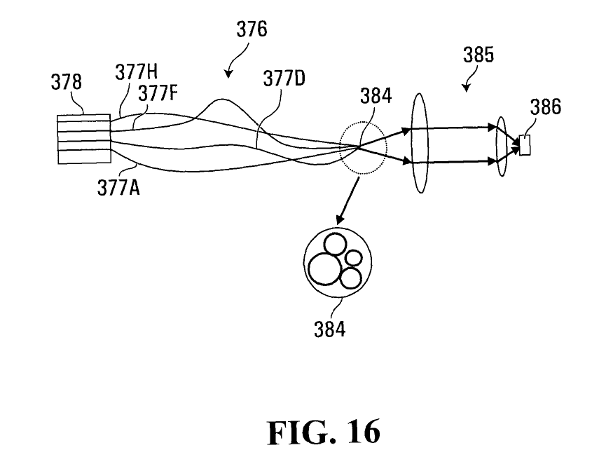

In another embodiment, the fibers can be combined together as a fiber bundle, and the tips of the bundle can be imaged on to a single detector or onto a single fiber, as for example shown in FIG. 16. Referring to FIG. 16, a plurality of fibers 377A, 377D, 377F and 377H extend from the mounting block 378 and the ends of the fibers are grouped together as a bundle 384. The detection system includes an image lens system 385 for directing the light onto a detector or single optical receiver 386, such as a fiber. Where the element 386 is an optical receiver, the receiver is coupled to a detector (not shown).

FIG. 17 shows an alternative embodiment of a beam generator for generating first and second beams for use in embodiments of the tracking or range measuring apparatus. Referring to FIG. 17, the beam generator, generally shown at 401, comprises a source 403, for example a laser, for producing a primary beam 405 of coherent electromagnetic radiation. The beam generator further comprises a beam splitter 407 for splitting the primary beam 405 into first and second beams 409, 411. The beam generator includes a first mirror 413, a beam modifier 415, a second mirror 417 and a filter 419. In operation, the beam splitter 407 directs the second beam 411 towards the first mirror 413 which reflects the second beam into the input of the beam modifier 415. The beam modifier comprises a device for changing the frequency of the second beam and may comprise, for example, an optical resonator, a frequency doubler or any other suitable device. The modified beam from the output of the beam modifier 415 is directed to the second mirror 417 and is reflected towards and passes through the filter 419. On the other hand, the first beam 409 is transmitted from the beam splitter 407 towards the filter 419 and is reflected thereby along the same direction as the frequency modified second beam 421. Thereafter, both beams can be introduced into the input of the beam steering section of the apparatus (if there is one), for example, the beam steering section of the embodiments of FIGS. 7 to 10.

The source 403 may be adapted to provide a pulsed beam to enable time of flight measurements to be made. In this case, both the first and second beams would be pulsed, but it is not expected that this would affect measurements based on the triangulation method. In other embodiments, the source may generate a continuous beam and the beam modifier may be adapted to pulse the beam, for example, through a voltage controlled optical filter. It is to be noted that in the embodiment of FIG. 17, as well as any other embodiments disclosed herein, it is not necessary to provide a pulsed beam for time of flight measurements. For example, in other embodiments, the beam may be continuous and the distance may be measured using the measurement of the phase difference between the launched and reflected beams.

Referring again to FIG. 17, one or more optional features may be included in the beam generator as follows. The beam generator may include one or more collimators, for example, collimator 431 for producing a collimated beam. Although the collimator 431 is positioned at the output of the source 403, the collimator could be positioned in any other suitable location.

The beam generator may include a power controller 433, 435 for controlling the power in the first and/or second beams. The power controller may comprise an amplifier or attenuator, or a combination of both. Providing a power controller in the path of at least one of the beams enables the power of one beam to be controlled independently of the other. In another embodiment, a power controller may be provided in the path of the primary beam before the beam splitter 407.

The beam generator may further include a beam conditioner 437, 439 for conditioning the first and/or second beams. The beam conditioner may comprise a beam expander (for example, either fixed or variable) for expanding the size of the beam and/or a focusing device for controlling the size of the projected beam as a function of distance. In some embodiments, the beam expander and focusing device may be integrated into a single unit.

Providing a beam conditioner in the path of at least one of the first and second beams allows at least one beam to be controlled independently of the other. If the first beam is used in the triangulation method, the beam size may be controlled to provide the required resolution. If the second beam is used for time of flight measurements, the beam may be expanded to reduce beam divergence over a relatively long distance, and may be expanded to a size which is larger than the size of the first beam. In one embodiment, the beam expander may be adapted to expand the beam for time of flight measurements to a diameter of, for example, 10 mm or more, 15 mm or more, 20 mm or more or 25 mm or more. The beam used for triangulation based measurements may have any suitable size and may either be collimated or focused (i.e. convergent) and may have any suitable size, for example, a size in the range of 1 to 25 mm or more.

FIG. 18 shows another embodiment of a beam generator which may be used in embodiments of the tracking apparatus. The beam generator is similar in some respects to that shown in FIG. 17, and like features are designated by the same reference numerals. The description of these features provided above in conjunction with FIG. 17 applies equally to the similar features shown in FIG. 18. The main difference between the embodiment of FIG. 17 and that of FIG. 18 is that in FIG. 18, the beam splitter and first mirror 407, 413 are replaced by a branched optical fiber 441. The unbranched portion 443 of the optical fiber 441 is positioned to receive energy from the source 403 and the branched portions 445, 447 split the energy into two parts for forming first and second beams. At the output of each branch 445, 447, a collimator 449, 451 forms a collimated beam. In other embodiments, any one or both collimators may be omitted.

In any of the embodiments described above, the beam source may comprise any suitable source of energy for producing a beam that can be reflected by an object whose distance or surface features are to be measured. For example, the beam source may comprise one or more sources of ordinary, non-coherent light or radiation, for example, an Ebium-doped fiber amplifier (EDFA) which produces non-coherent radiation. The sources may be adapted to restrict the range of wavelengths of light or radiation in the beam, for example, by providing a monochromatic light source or using any one or more suitable filters. The beam used in the triangulation method of measurement may either be pulsed or continuous. The beam used in the time of flight measurement may be either pulsed or continuous.

In another aspect and embodiment, the beam generator may generate only one beam at any one time, and simply modify the single beam by switchably coupling a beam modifier into and out of the beam to generate the other of the first and second beams.

Any optical component described herein may be replaced by any other optical component which provides a similar function, operates in a similar way, has a similar structure, and/or provides a similar result. For example, the prism which is used to introduce the beams into the beam steering system may be replaced by any other suitable reflector, such as a mirror. Similarly, any mirror disclosed herein may be replaced by any other suitable component which changes the direction of the beam, for example any other suitable reflector, waveguide (e.g. light pipe) or other component which performs a similar function.

In some embodiments, a beam expander may be provided to control the beam size of the first or second beam, or any other additional beam that may be used in the measurements. In one simple implementation, the beam expander may comprise a lens positioned in front of the end of a waveguide such as an optical fiber. The launch angle or angle of divergence of the beam from the output of the waveguide or fiber may be predetermined and fixed or controllable. The beam width at the lens could be independently controllable by means of an aperture. Alternatively, or in addition, the size of the beam may be controlled by changing the distance between the lens and the waveguide output. The focal length of the beam projected beyond the lens may also be controlled by changing the distance between the lens and the waveguide or fiber.

In an alternative embodiment, a time of flight detector may be positioned on the projection side of the apparatus so that the detected beam is one which returns along the same or similar path to the projected beam.

Other embodiments and aspects of the invention may include any one feature described or disclosed herein in combination with any one or more other features described or disclosed herein. In any aspect or embodiment of the invention, any one or more feature(s) may be omitted altogether, or replaced by another feature which may be an equivalent or variant thereof. Any feature from the description may be incorporated into any embodiment or aspect of the invention disclosed or claimed herein.

Modifications to the embodiments described above will be apparent to those skilled in the art.

1. An apparatus comprising beam generating means for generating first and second beams of energy,
receiving means for receiving said first and second beams reflected from a target surface whose distance from said apparatus is to be measured, wherein said receiving means includes a detector for detecting the position of the reflected first beam at said apparatus, and wherein said position is dependent on the angle between the incident and reflected first beam at the target surface and thereby on distance between said apparatus and the position from which said first beam is reflected from said surface.

2. An apparatus as claimed in claim 1, wherein said detector comprises a detector for detecting changes in the position of the reflected first beam at said apparatus resulting from changes in the distance between said apparatus and the position from which said first beam is reflected from said surface.

3. An apparatus as claimed in claim 1, wherein said receiving means further comprises means for directing the reflected second beam to a second detector for detection thereof.

4. An apparatus as claimed in claim 1, wherein said receiving means further comprises a second detector for detecting said second beam reflected from said surface.

5. An apparatus as claimed in claim 1, wherein said beam generating means is adapted to generate said first beam with at least one characteristic that is different from said second beam.

6. An apparatus as claimed in claim 5, wherein said characteristic comprises wavelength/frequency.

7. An apparatus as claimed in claim 1, wherein said beam generating means is adapted to generate said second beam as a pulsed beam.

8. An apparatus as claimed in claim 1, wherein said beam generating means is adapted to generate said first beam as a continuous beam.

9. An apparatus as claimed in claim 1, wherein said beam generating means is adapted to generate said first and second beams as pulsed beams, wherein said first beam is pulsed at a different frequency to said second beam.

10. An apparatus as claimed in claim 1, wherein said beam generating means is adapted to generate said second beam as a pulsed beam, and said receiving means comprises a second detector for detecting said second beam reflected from said surface, said second detector being arranged to detect the time period between a transmitted or reference pulse and a received pulse for measuring the distance between said surface and said apparatus.

11. An apparatus as claimed in claim 1, further comprising control means for controlling the direction of at least said first beam away from said apparatus.

12. An apparatus as claimed in claim 11, wherein said control means is adapted to control the direction of said second beam.

13. An apparatus as claimed in claim 11, further comprising reflector means for introducing at least one of said first and second beams to said control means.

14. An apparatus as claimed in claim 13, wherein said reflector means comprises at least one of a planar mirror and a prism.

15. An apparatus as claimed in claim 11, wherein said control means comprises first and second spaced apart moveable elements for changing the position of the beams, and said apparatus is arranged such that said beams are introduced between said first and second elements in a direction generally transverse to the direction in which said elements are spaced apart.

16. An apparatus as claimed in claim 1, comprising means for directing said first and second beams in substantially the same direction away from said apparatus.

17. An apparatus as claimed in claim 1, further comprising means for superimposing the first and second beams on each other.

18. An apparatus as claimed in claim 1, further comprising means for spatially separating the reflected first and second beams.

19. An apparatus as claimed in claim 18, wherein said first and second beams have different wavelengths and said separating means spatially separates the reflected first and second beams by virtue of their different wavelengths.

20. An apparatus as claimed in claim 19, further comprising collector means for receiving the second beam from said separating means and redirecting said beam laterally to the incident beam direction.

21. An apparatus as claimed in claim 20, further comprising a conduit having an input, said input being positioned to receive reflected beam energy from said collector means.

22. An apparatus as claimed in claim 20, wherein said collector means comprises any one or more of a diffuser for diffusing the beam, a diffractive optical element, a lens device for defocusing and/or redirecting said beam and a device for increasing the size of the beam in at least one direction.

23. An apparatus as claimed in claim 1, further comprising scanning means for scanning the first beam in the plane containing the incident and reflected first beams.

24. An apparatus as claimed in claim 1, further comprising scanning means for scanning the first beam in a direction orthogonal to the plane containing the incident and reflected first beams.

25. An apparatus as claimed in claim 1, wherein the second beam has a different diameter than the first beam at least one of (i) at the position at which said beams leave said apparatus, (ii) at said target surface, and (iii) at a position along the path of said beams in the projection direction away from said apparatus towards said surface.

26. An apparatus as claimed in claim 1, wherein at least one of said first and second beams comprises a beam of coherent electromagnetic radiation.

27. An apparatus as claimed in claim 1, wherein said beam generating means comprises at least one laser.

28. An apparatus as claimed in claim 27, wherein said beam generating means comprises a first laser for generating said first beam and a second laser for generating said second beam.

29. An apparatus as claimed in claim 18, wherein said separating means comprises a dichroic filter or other filter means.

30. An apparatus as claimed in claim 1, wherein said receiving means further comprises lens means for focusing and/or controlling the size of the beam at said detector.

31. An apparatus, as claimed in claim 1, wherein said receiving means further comprises means for controlling the intensity/power or amount of the reflected second beam directed to a detector for detecting said second beam.

32. An apparatus as claimed in claim 1, wherein said receiving means further comprises means for controlling the power/intensity or amount of the first beam incident on said detector for detecting said first beam.

33. An apparatus as claimed in claim 31, wherein said control means is adapted to at least one of limit the amount of the reflected beam passed to the detector, limit said amount if the received amount for passing to said detector exceeds a threshold value, and control the range of the amounts of the reflected beam passed to the detector, control the amount of beam energy at the detector as a function of the position of the received beam energy resulting from the angle at the target between the projected beam and received beam energy.

34. An apparatus as claimed in claim 1 further comprising means for controlling at least one parameter of at least one of said first and second projected beams.

35. An apparatus as claimed in claim 34, wherein said means comprises any one or more of (a) means for controlling the size of the beam, (b) a beam expander means, (c) means for collimating said beam, (d) means for controlling the power of said beam, means for controlling convergence and/or divergence of said beam, (e) means for controlling the beam size at said target surface, and (f) focusing means for focusing said beam.

36. An apparatus as claimed in claim 1, wherein said beam generating means further comprises an optical fiber or other conduit or waveguide, for carrying energy from a source of said beam energy.

37. An apparatus comprising projection means for projecting first and second beams of electromagnetic energy towards a target surface, receiving means for receiving beam energy reflected from the target surface, and detection means for detecting the received beam energy.

38. An apparatus as claimed in claim 37, wherein said projection means further comprises input means for receiving said first and second beams.

39. An apparatus as claimed in claim 38, wherein said input means comprises a first input for receiving said first beam and a second input for receiving said second beam.

40. An apparatus as claimed in claim 39, further comprising means for directing said first and second beams from said first and second inputs at least one of (i) along substantially the same direction, (ii) for positioning said beams to be coincident with one another or positioned proximate one another.

41. An apparatus as claimed in claim 40, wherein said directing means includes filter means for discriminating between said first and second beams, for example a dichroic filter.

42. An apparatus as claimed in claim 37, wherein said projection means further comprises a source for producing said first and second beams.

43. An apparatus as claimed in claim 42, wherein said source comprises a first source for producing said first beam and a second source for producing said second beam.

44. An apparatus as claimed in claim 42, wherein said projection system comprises an input for receiving beam energy from said source, and said apparatus further comprises guide means for guiding beam energy for at least one of said first and second beams from said source to said input.

45. An apparatus as claimed in claim 37, wherein said projection means comprises at least one of (a) a beam expander for expanding a cross-sectional dimension of one or both of said first and second beams, (b) a controller for varying a cross-sectional dimension of one or both of said first and second beams, (c) a focussing device for controlling an amount of convergence of one or both of said first and second beams and (d) a controller for controlling the power/intensity of one or both of said first and second beams.

46. An apparatus as claimed in claim 37, wherein said projection means further comprises steering means for controlling the direction of at least one of said first and second beams.

47. An apparatus as claimed in claim 46, further comprising directing means for directing said first and second beams along substantially the same direction and/or positioning said beams substantially coincident with one another or proximate one another, and for introducing said first and second beams to said beam steering means.

48. An apparatus as claimed in claim 46, wherein said beam steering means is capable of steering said beam in at least one direction.

49. An apparatus as claimed in claim 47, wherein said receiving means further comprises a beam steering system for steering the reflected beam onto said detector.

50. An apparatus as claimed in claim 49, wherein the steering means of said projection means and the steering means of said receiving means are arranged to move said projected and reflected beams such that the reflected beam output from the beam steering system of the receiving means remains substantially in the same position as the projected beam traverses a plane substantially orthogonal to the range direction.

51. An apparatus as claimed in claim 48, wherein said receiving means further comprises lens means for focusing and/or controlling the received beam from the beam steering system onto the detector.

52. An apparatus as claimed in claim 37, wherein said detector comprises a position detector for detecting the position of the received first beam.

53. An apparatus as claimed in claim 37, wherein said receiving means further comprises means for focusing and/or controlling the size of the first beam on said detector.

54. An apparatus as claimed in claim 53, wherein said means comprises lens means.

55. An apparatus as claimed in claim 53, wherein said receiving means further comprises separating means for spatially separating the first beam from the second beam after passing through said beam size controlling means.

56. An apparatus as claimed in claim 55, wherein said receiving means further comprises means for directing said second beam to a second detector.

57. An apparatus as claimed in claim 56, wherein said directing means includes an input for receiving said second beam and said receiving means further comprises collector means for collecting said second beam and directing said second beam laterally towards said input.

58. An apparatus as claimed in claim 56, wherein said directing means comprises guide means for guiding said second beam to said second detector.

59. An apparatus as claimed in claim 56, wherein said receiving means further comprises control means for controlling the amount of said second beam directed to said second detector.

60. An apparatus as claimed in claim 59, wherein said control means is adapted to limit the range of the amounts of said second beam directed to said second detector.

61. An apparatus as claimed in claim 59, wherein the position of the received second beam is dependent on the range of the target surface, and said control means is adapted to control the amount of energy of the second beam on said second detector as a function of said position of said received second beam.

62. An apparatus as claimed in claim 37, wherein said detector means comprises a first detector means for detecting said first beam and a second detector for detecting said second beam.

63. An apparatus as claimed in claim 62, wherein said detector means is adapted to measure a parameter indicative of a time for said second beam to travel along the second beam path to enable the range or position of said target surface to be determined.

64. An apparatus as claimed in claim 37, wherein said receiving means further comprises beam steering means for controlling the direction of the reflected beam.

65. An apparatus as claimed in claim 37, wherein said receiving means further comprises lens means for controlling the size of the reflected beam and/or focusing the reflected beam.

66. An apparatus as claimed in claim 37, wherein said receiving means further comprises separating means for separating the first and second beams.

67. An apparatus as claimed in claim 66, wherein said separating means comprises a filter, for example a dichroic filter.

68. An apparatus as claimed in claim 37, wherein said first beam has at least one parameter having a different value to that of said second beam.

69. An apparatus as claimed in claim 68, wherein said parameter comprises wavelength/frequency.

70. An apparatus as claimed in claim 37, wherein said second beam is pulsed.

71. An apparatus as claimed in claim 37, wherein said receiving means is adapted to receive said reflected beam where said reflected beam is reflected at an angle to said projected beam.

72. An apparatus as claimed in claim 37, further comprising determining means for determining the range of said target surface based on the position of said reflected beam using triangulation.

73. An apparatus as claimed in claim 37, further comprising determining means for determining the range of said target surface based on the received second beam using time of flight.

74. A receiver for receiving a beam reflected from an object, guide means for receiving beam energy and having an input, and collector for receiving said reflected beam and directing beam energy to said input, wherein said collector means is adapted to redirect at least part of the beam from the direction in which said collector receives said beam.

75. A receiver as claimed in claim 74, wherein said collector comprises a diffuser for diffusing said beam and/or a diffractive optical element, or another device for changing the direction of at least part of said beam and causing at least a portion of said beam to diverge.

76. A receiver for receiving a beam of energy reflected from an object, the position of the received beam depending on the range of the object from the receiver, the receiver comprising converter means for converting the beam energy into a signal and a controller for controlling the strength of the signal in response to changes in said position.

77. A receiver as claimed in claim 76, wherein said controller is adapted to control the amount of beam energy at the converter as a function of said position.

78. A receiver as claimed in claim 77, wherein said controller comprises a collector for receiving beam energy and coupled to said converter, and means for directing a quantity of beam energy into said collector, where the quantity varies with said position.

79. A receiver as claimed in claim 78, wherein said controller comprises at least one of a diffuser, a diffractive optical element, a means for moving the collector relative to the focal plane of the beam, a means for moving the focal plane of the beam relative to said collector, and a means for moving the collector transverse to the beam line.

80. A receiver as claimed in claim 77, wherein said controller comprises a plurality of collectors arranged along a direction in which the received beam changes position.

81. A receiver as claimed in claim 80, wherein at least one of said collectors has a different cross-sectional area to at least one other collector.

82. A receiver as claimed in claim 80, wherein at least one collector has a different transmission coefficient to at least one other collector.

83. A receiver as claimed in claim 82, wherein one or more collectors has a coating or layer of material to provide a different transmission coefficient to that of at least one other collector.

84. A receiver as claimed in claim 80, further comprising means for moving at least one or more collector relative to the focal plane of the beam and/or for moving at least one or more collector transverse to the beam line.

85. A receiver as claimed in claim 76, wherein said controller comprises at least one of an optical attenuator and an optical amplifier.

86. A receiver as claimed in claim 76, wherein said converter means comprises a plurality of converters positioned at different positions along the direction in which the beam changes position, and wherein the ratio of the strength of beam input to the strength of the signal output for at least one converter is different to said ratio for one or more other converters.

87. A receiver as claimed in claim 86, wherein the gain of one or more converters is different to the gain for one or more other converters.

88. A receiver as claimed in claim 76, further comprising determining means for determining the range to the object based on the time taken to receive the beam from the object.

89. A method for measuring the position of a target surface, comprising the steps of projecting first and second beams of energy onto said target surface, receiving said first and second beams from said target surface and determining said position based on a characteristic of the first and second received beams.

90. A method as claimed in claim 89, wherein said characteristic includes the position of said first beam at a detector.

91. A method as claimed in claim 89, wherein said characteristic includes a characteristic of said second beam indicative of the time for said second beam to travel along the path of the second beam.

92. A method as claimed in claim 89, wherein said first and second beams received from said target surface are at least partially co-located.

93. A method as claimed in claim 92, further comprising spatially separating the reflected first and second beams.

94. A method as claimed in claim 89, further comprising changing the trajectory of said first and second beams using the same steering mechanism.

95. A method as claimed in claim 89, wherein said first and second projected beams are at least partially co-located.

96. A method as claimed in claim 89, wherein a parameter of said first beam has a different value to that of said second beam.

97. A method as claimed in claim 93, wherein said beams have different values of a parameter, and said beams are separated based on said different parameters.

98. A method as claimed in claim 97, wherein said parameter is wavelength.

99. A method as claimed in claim 89, wherein said first and second beams are generated at the same time or not at the same time.

100. An apparatus, comprising beam generating means for generating first and second beams of energy, receiving means for receiving first and second beam energy reflected from a target surface whose distance from the apparatus is to be measured, and for projecting received beam energy from one of said first and second beams onto a detector wherein the detector comprises one of a position detector for detecting the position of the beam energy and a time-of-flight detector.

101. (canceled)
